(19) United States
(12) Patent Application Publication
(10) Pub. No.: US 2019/0080057 A1
(43) Pub. Date: Mar. 14, 2019

(54) TOXICITY OR ADVERSE EFFECT OF A SUBSTANCE PREDICTING AUTOMATED SYSTEM AND METHOD OF TRAINING THEREOF

(71) Applicants: Michael STANLEY, New York, NY (US); Eric TANALSKI, New York, NY (US); Peter TERLECKY, New York, NY (US); Richard WENDELL, New York, NY (US)

(72) Inventors: Michael STANLEY, New York, NY (US); Eric TANALSKI, New York, NY (US); Peter TERLECKY, New York, NY (US); Richard WENDELL, New York, NY (US)

(21) Appl. No.: 16/129,551

(22) Filed: Sep. 12, 2018

Related U.S. Application Data
(60) Provisional application No. 62/557,505, filed on Sep. 12, 2017.

(51) Int. Cl. G06K 9/62

(52) U.S. Cl. CPC G06F 19/704; G06F 19/24; G06F 19/20; G06F 19/707; G06K 9/6256; G06F 19/705

(57) ABSTRACT

A system of generating a suitability and/or toxicity score for a compound of interest is described. The system may be trained by obtaining physical properties of compounds; retrieving or predicting physiological binding sites or targets of the compound; and using clinical data for known compounds and interactions. Suitability or toxicity for a compound of interest may be obtained based upon a machine-learning prediction. In such a system, the clinical descriptions for the compound may include at least one of an indication for use of the compound and a therapeutic area of the compound, and also may include the use of gene expression strength metrics.

### CROSS-REFERENCE TO RELATED APPLICATIONS

The present non-provisional patent application claims priority to U.S. Provisional Application No. 62/557,505, filed Sep. 12, 2017, the entire disclosure of which is incorporated by reference herein.

### BACKGROUND OF THE DISCLOSURE

Pharmaceutical research in laboratories and clinical trials is expensive, potentially dangerous, and time consuming, and therefore the screening of unsuitable compounds without laboratory research and without clinical trials is of great help for researchers. Hosts of organic and inorganic compounds are available for pharmaceutical research and the early elimination of some compounds from further research due to their likely toxicity, adverse/side effects or failure to be granted regulatory approval is of immense help to clinical researchers. The present disclosure concerns a digital approach to find unsuitable compounds, that is compounds that are likely to fail clinical trials or to fail to obtain FDA approval due to their toxicity or adverse effects. Additionally, this approach can be used to rank approved (or approvable) compounds by their relative toxicity and side effects for the purposes of commercial predictions and planning.

S. Novotarskyi et al., “ToxCast EPA in Vitro to in Vivo Challenge: Insight into the Rank-I Model,” Chemical Research in Toxicology, 29:768-775, 2016; D. Duvenaud et al., “Convolutional Networks on Graphs for Learning Molecular Fingerprints,” Harvard University, Nov. 3, 2015; K. Gayvert et al., “A Data-Driven Approach to Predicting Successes and Failures of Clinical Trials,” Cell Chemical Biology, 23:1294-1301, Oct. 20, 2016. Each of these prior art references is incorporated in full herein and is appended hereto as, respectively, Appendices A, B and C.

Also known are U.S. Pat. Nos. 9,536,194, 7,698,157, 7,883,858, 7,979,373, 6,970,790, 8,645,075 and U.S. Patent Application Publication Nos. 2002/0036166, 2003/0004652, 2006/0112105, 2008/0306918, 2010/0169853, 2010/0198616, 2011/0010099, 2011/0113002, 2011/0262496, 2012/0029896, 2012/0265548, 2012/0296090, 2012/0303388, 2013/0041683, 2013/0138478, 2013/0144636, 2013/0179138, 2013/0179375, 2014/0193517, 2014/0351963, 2009/0132464, 2004/0083060, 2017/0270239. Each of these patents and patent application publications is incorporated in full by reference herein.

The figures of the Drawings illustrate examples of aspects of the invention. Other features and advantages of the present invention will become apparent from the following description of the invention, and/or from the combination of one or more of the figures and the textual description herein, which refers to the accompanying Drawings.

### SUMMARY

A system, device, method, and the means for providing such a method are described for providing improved flagging or detection of compounds that are unpromising or unsuitable, so that clinical research may focused on promising pharmaceutical compounds. A system for generating an suitability and/or toxicity score for a compound of interest may include: a known clinical outcome score generator configured to generate a set of suitability outcome scores for a first set of compounds based on a set of clinical known trial data, each suitability outcome score of the suitability outcome scores representing an outcome of a clinical trial of a compound of the first set of compounds; a compound physical property data processor configured to obtain physical properties of a molecule or of atoms of each compound of a first set of compounds, and configured to obtain a known molecular target of each compound of a first plurality of compounds of the first set of compounds; a binding classifier configured to predict for compounds of a second plurality of the first set of compounds respective molecular targets; a therapeutic area indicator configured to obtain for each compound of the first set of compounds a therapeutic area; and a trainer configured to generate a set of suitability scores yielded, respectively, by a set of inputs, each input including a compound of the first set of compounds, the set of suitability scores generated, based on the therapeutic area data generated, using a machine learning process comprising at least one of a gradient-boosted tree method, a deep neural network method, a convolutional neural network method, a graph-based convolutional neural network method, and a Bayesian network method.

Such a system may also include a machine learning optimizer configured to optimize the machine learning of the trainer based on a testing data set comprising a set of input vectors and scored suitability outcomes.

Such a system may also include a machine learning optimizer configured to optimize the machine learning of the trainer based on a testing data set comprising a set of input vectors, each input vector of the set of input vectors comprising a first known molecular target, a first known binding descriptor set, and a first set of physical compound properties.

Such a system may also include a compound inferencer configured to generate the suitability score for the compound of interest based on the set of suitability scores generated by the trainer.

Such a system may also include a gene interaction enumerator configured to obtain a genetic pathway controlled by a respective molecular target; a gene expression metric generator configured to identify a metric of gene expression strength for each tissue of a plurality of tissues.

In such a system, the gene interaction enumerator may be configured to obtain the set of genetic pathways from a database.

In such a system, the gene interaction enumerator may be configured to generate the suitability score based upon a weighted sum of gene interactions.

In such a system, the gene expression metric generator may be configured to identify the metric as a metric of the relative expression strength and a Boolean expression location, and the therapeutic area indicator may be configured to generate therapeutic area data by obtaining a therapeutic area according to the expression strength metric of the respective compound.

In such a system, the compound physical property data processor may be configured to obtain physical properties including at least one of molecular mass, water solubility, xLogP, refractivity, chirality, electromagnetic moments, atomic bond energies, atomic orbitals, H-bond donor/acceptor counts, molecular surface area, and intrinsic coordinates.

In such a system, the compound physical property data processor may be configured to compute a chemical fingerprint.

In such a system, the compound physical property data processor may be configured to obtain a standard molecular physical property from a database.

In such a system, the compound physical property data processor may be configured to extract, for each atom in a molecular of a compound, relative Cartesian coordinates, valence, hybridization, and formal change.

In such a system, the compound physical property data processor may be configured to compute an electric moment using hybridization and formal change.

In such a system, the compound physical property data processor may be configured to compute principle moments of a molecule of the compound.

In such a system, the compound physical property data processor may be configured to compute a chemical fingerprint of the compound.

In such a system, the suitability score indicates a likelihood that a compound will fail in any phase of clinical trials due to toxicity.

In such a system, the suitability score indicates a likelihood that a compound will fail to obtain regulatory approval for sale due to toxicity.

In such a system, the suitability score may be a metric indicating a likely severity of adverse effects of a compound.

In such a system, the suitability score indicates a relative toxicity of a compound compared to another compound.

In such a system, the suitability score indicates a relative toxicity of a compound compared to a competitive market of a compound.

In such a system, the suitability score indicates at least one of suitability or toxicity of the compound.

Such a system may include a binding classifier builder configured to build a binding classifier that predicts binding between a first compound of a third set of compounds and a first molecular target of a third set of molecular targets based on physical properties of the first compound, and to predict binding between a second compound of the third set of compounds and a second molecular target of the third set of molecular targets based on the physical properties of the second compound, the binding classifier builder configured to build the binding classifier builder by obtaining from a database, for each compound of a second set of compounds, a known molecular target, known binding descriptors, and physical compound properties.

In such a system, the binding classifier builder builds the binding classifier using a first machine learning process comprising at least one of a gradient-boosted tree method, a deep neural network method, a convolutional neural network method, a graph-based convolutional neural network method, and a Bayesian network method.

In such a system, the system automatically standardizes the compound before obtaining the physical properties.

Also disclosed is a method of generating a suitability score for a compound of interest, the system including: generating a set of suitability outcome scores for a first set of compounds based on a set of clinical trial data, each suitability outcome score of the suitability outcome scores representing an outcome of a clinical trial of a compound of the first set of compounds; obtaining physical properties of a molecule or of atoms of each compound of a first set of compounds, and obtaining a known molecular target of each compound of a first plurality of compounds of the first set of compounds; obtaining for each compound of the first set of compounds a therapeutic area; and generating a set of suitability scores yielded, respectively, by a set of inputs, each input including a compound of the first set of compounds, the set of suitability scores generated using a machine learning process comprising at least one of a gradient-boosted tree method, a deep neural network method, a convolutional neural network method, a graph-based convolutional neural network method, and a Bayesian network method.

Such a method may also include predicting, for compounds of a second plurality of the first set of compounds, a respective first set of molecular targets; obtaining a genetic pathway of a set of genetic pathways controlled by a respective molecular target of the first set of molecular targets; and identifying a metric of gene expression strength for each tissue of a plurality of tissues.

Also disclosed is a system of generating a suitability and/or toxicity score for a compound of interest, the system including: a physical properties obtainer configured to obtain physical properties of the compound; a binding sites obtainer configured obtain physiological binding sites or targets of the compound; a machine-learner configured to predict additional physiological binding sites or targets of the compound; and an inference configured to determine at least one of suitability or toxicity for a compound of interest based upon the machine-learner prediction and to output a result of the determination of the at least one of suitability or toxicity.

Such a system may also include a compound clinical descriptions obtainer configured to obtain clinical descriptions for the compound.

In such a system, the clinical descriptions for the compound include at least one of an indication for use of the compound and a therapeutic area of the compound.

Such a system may also include a known compound trainer configured to receive known clinical trial results and compound toxicity scores for a given compound, and to update the machine-learner accordingly.

In such a system, the known compound trainer may be configured to update the machine learner on-line.

Other aspects of the invention are described in the sections and figures that follow.

### BRIEF DESCRIPTION OF THE FIGURES

FIG. 1 is an illustration of an example of a flow chart illustrating processing performed according to an aspect of the disclosure.

FIG. 2 is an illustration of an example of a flow chart for obtaining a given compound of interest for scoring through obtaining the suitability/unsuitability score, according to an aspect of the disclosure.

FIG. 3 is an illustration of an example of a compound suitability/unsuitability profiler, according to an aspect of the disclosure.

FIGS. 4A-4C are an illustration of an example of a more detailed flow chart showing the flow of processes, according to an aspect of the disclosure.

### DETAILED DESCRIPTION OF THE EMBODIMENTS

The present methods, functions, systems, computer-readable medium products are designed to compute a likelihood that a compound will fail in any phase of clinical trials due to toxicity, a likelihood a compound will be more/less toxic relative to a competitor or a likelihood that a compound will fail to obtain FDA approval for sale/marketing due to toxicity using a metric scoring a likelihood of adverse effect, a severity of adverse effects, a relative toxicity of the series compared to each other, and a relative toxicity of the compound compared to the competitive market.

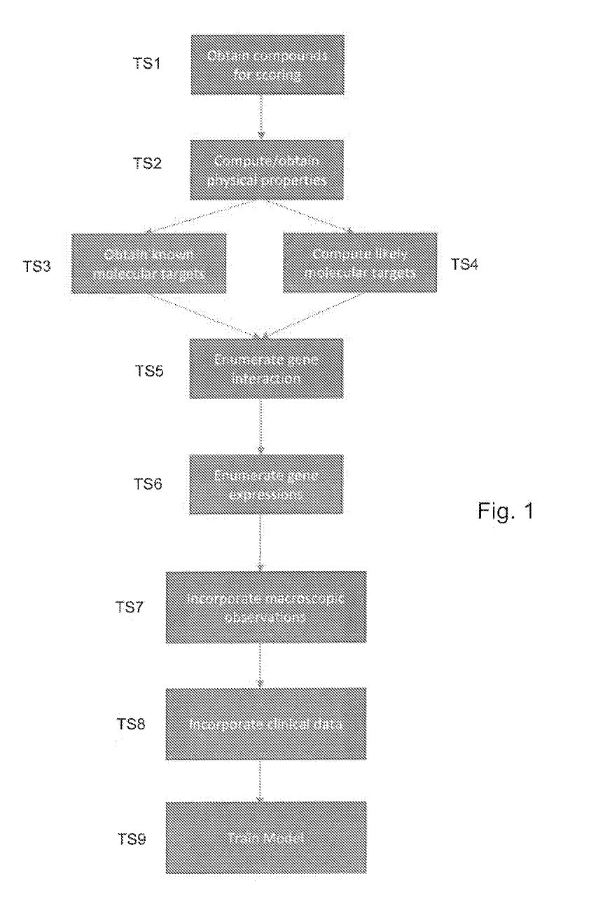

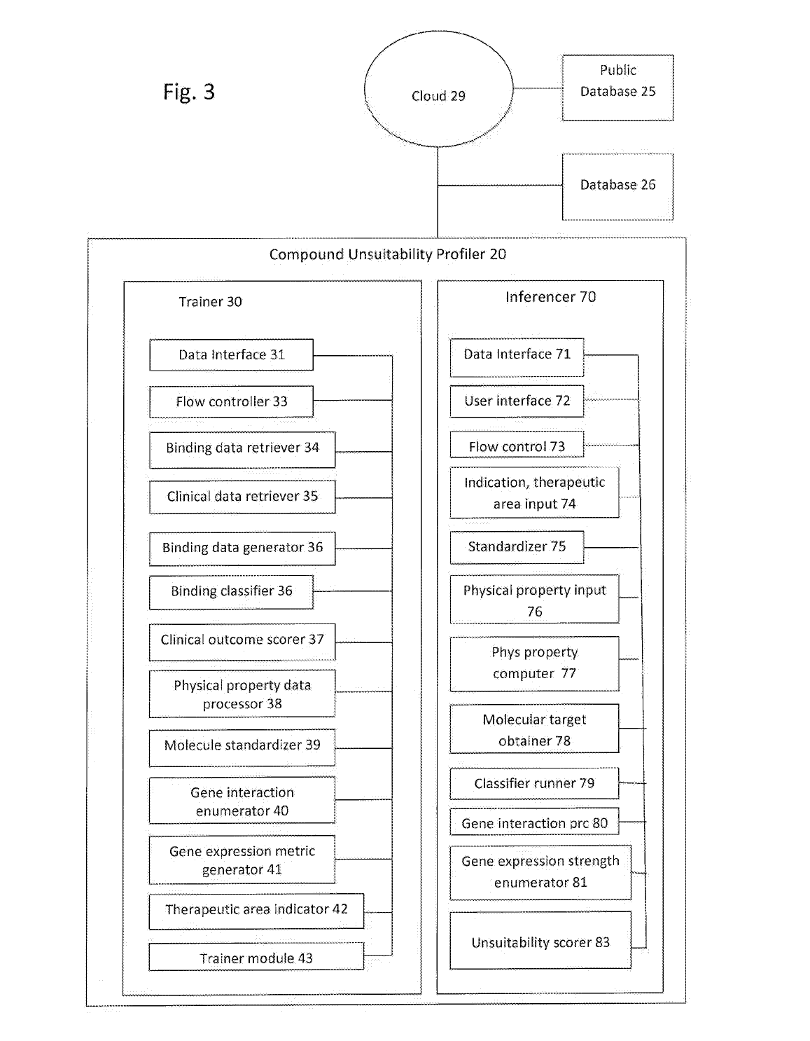

The system may include a trainer 30, illustrated in FIG. 3 that obtains known clinical data and uses machine learning to score relative compound toxicity and/or likelihood of failure based on an input vector for a compound, the input vector including a known molecular target, one or more known binding descriptors, physiological information about the disease pathway and physical properties of the compound. According to an aspect of the disclosure, users may add their own data and update the model online after it has been already trained. Further, the system may include an inferencer 70 illustrated in FIG. 3 that can assign a score or ranking for a compound in response to user inquiry. One high level flow of the process of the trainer 30 is illustrated in FIG. 1.

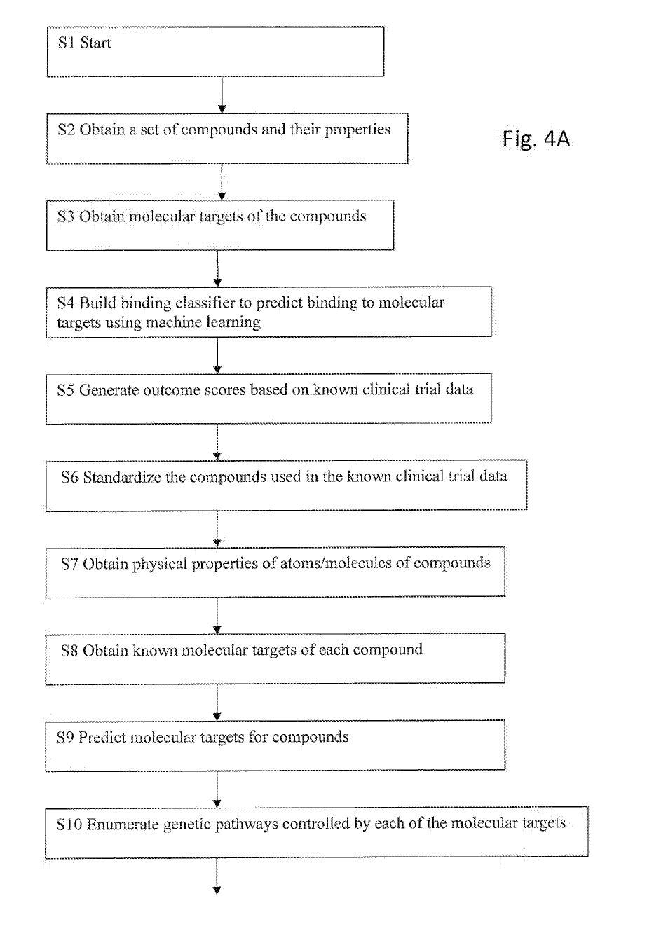

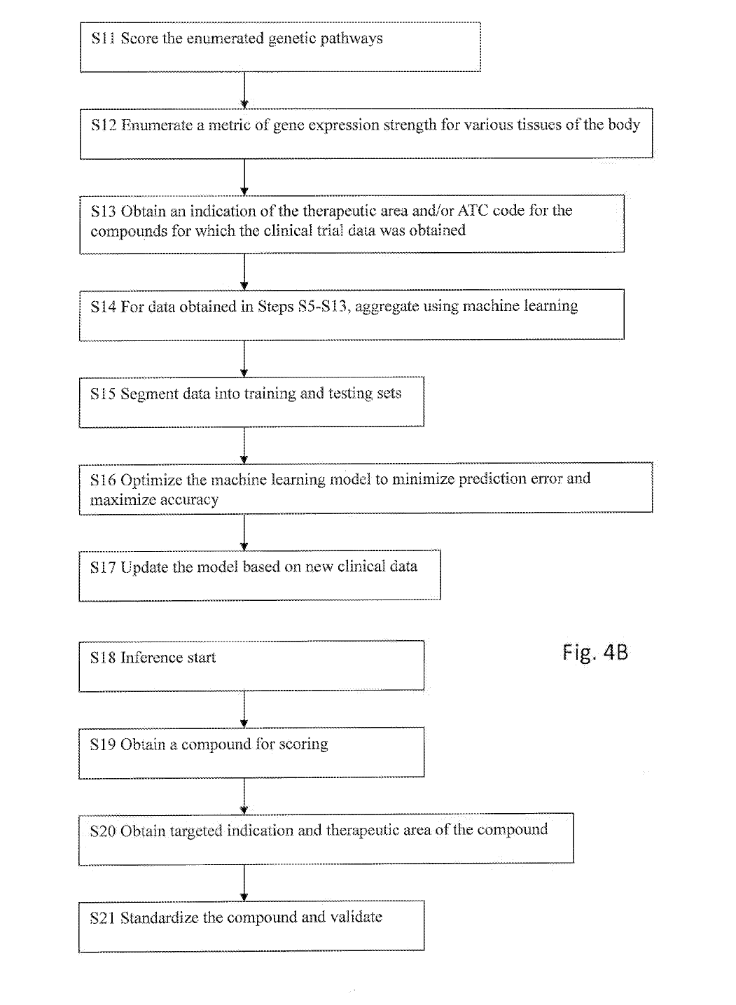

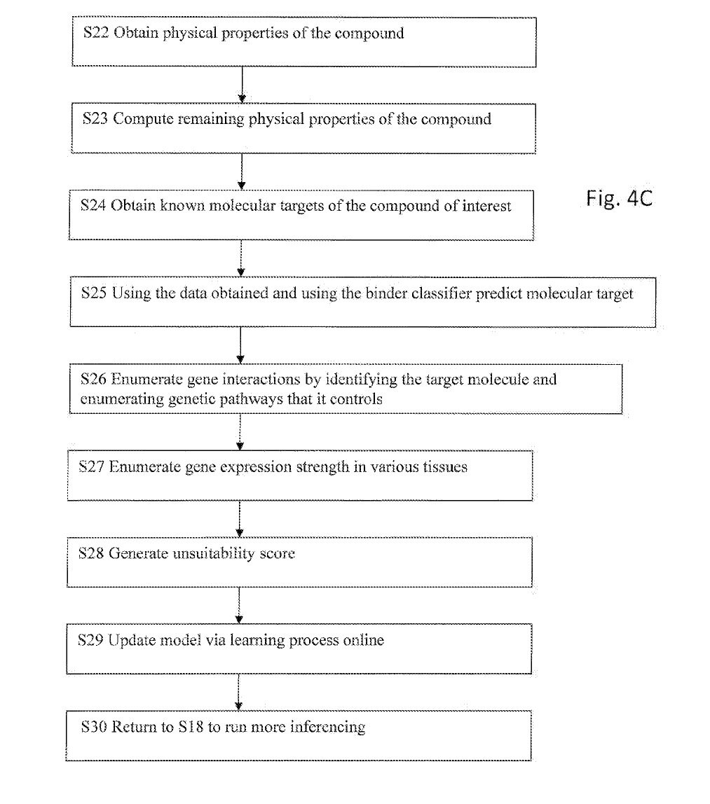

A flowchart illustrating an example of a working of a system according to the present disclosure will now be explained with respect to FIGS. 1 and 4A-4C.

### Physical Property Enumeration & Standardization

An example of a physical property information obtaining and standardizing process may be as follows. After system start at TS1, a set of compounds may be obtained at TS2 of FIG. 1. First the compounds may go through a standardization process.

For example, starting with the generic name, brand name, chemical name, or isomeric SMILES of the compound, or using publicly available chemoinformatics libraries,

Willighagen, May and Steinbeck. Efficient ring perception for the Chemistry Development Kit. J. Cheminform. 2014,doi:10.1186/1758-2946-6-3 (hereinafter May and Steinbeck), Steinbeck et al. Recent Developments of the Chemistry Development Kit (CDK)—An Open-Source Java Library for Chemo- and Bioinformatics. Curr. Pharm. Des. 2006; 12(17):2111-2120,doi:10.2174/138161206777585274 (hereinafter Steinbeck “Recent Developments”). Steinbeck et al. The Chemistry Development Kit (CDK): An Open-Source Java Library for Chemo- and Bioinformatics. J. Chem. Inf. Comput. Sci. 2003 March-April; 43(2):493-500, doi:10.1021/ci025584y (hereinafter Steinbeck “The Chemistry Development Kit”) to standardize the molecule.

Also using such or similar libraries, the final chemical formula may be validated. If the validation fails, we may revert to the starting chemical formula.

Then, physical properties of the compound may be obtained, for example, starting with the chemical formula, the standard molecular physical properties may be obtained from publicly available references, such as Willighagen et al. The Chemistry Development Kit (CDK) v2.0: atom typing, depiction, molecular formulas, and substructure searching. J. Cheminform. 2017; 9(3), doi:10.1186/s13321-017-0220-4 (hereinafter Willighagen). Also see in this connection Thiessen, RDKit, Bento and Jupp discussed below.

For example, such obtained properties may include molecular mass, water solubility, xLogP, refractivity, chirality, electromagnetic moments, atomic bond energies, atomic orbitals, valence bond shape, H-Bond donor/acceptor counts, molecular surface area, intrinsic coordinates, etc. Additionally, chemical fingerprint hashes may be computed.

For example, sodium chloride has a chemical formula of NaCL. Its molecular weight is 58.4428 Daltons. It has a solubility of 35.65 g/100 mL water. It has a formal charge of 0, a Hydrogen donor count of 0, a Hydrogen acceptor count of 1 and an index of refraction of 1.5442.

For each atom in a molecule, relative Cartesian coordinates may be extracted, and also the valence hybridization, the formal charge and other physical properties may be extracted using sources, such as RDKit, Bento and Jupp. Valence hybridization is computed via VSEPR theory (Valence Shell Electron Pair Repulsion) and is available via reference in standard industry texts.

The electric moment may be computed to as many orders as possible, or to as orders as necessary at this stage, for example, using hybridization and formal charge. Any values that are not possible to compute due to molecule size may be set to zero. The information for this step may be found in Jackson, John David. Classical Electrodynamics Third Edition. John Wiley and Sons, Inc., 1999. Pp 145-150 (hereinafter Jackson), and in Gibbs, Julian H. Hybridization and the Dipole Moment. J Phys Chem, 1955 59(7), pp 644-649 (hereinafter Gibbs) and Harrison, Walter A. Electronic Structure and the Properties of Solids. W.H Freeman and Company, San Francisco, 1980 (hereinafter Harrison).

For example, a water molecule consists of two Hydrogen atoms and one Oxygen atom. The dipole moment of an OH bond is 1.5 DeBye and the bond angle between the oxygen atoms is 104.5 degrees, via reference. To calculate the dipole moment of the water molecule, we use the definition of the electric dipole moment from Jackson.

p=Σqᵢrᵢ=Σpᵢ

where p is the dipole moment vector,
q is the charge of the individual electric sources,
rᵢ is the vector distance to the charge, and
pᵢ is the dipole moment of individual electric sources.
To apply this to the water molecule, we may project the OH dipole moment onto the long axis of the molecule using the geometry:

r=r₀ cos(a)

and add the two dipole moments. This yields

r=1.5 D×cos(52.25)×2=1.89 D. Then the principle moments of the molecule may be computed as discussed in Goldstein, H., Poole, C. and Safko, J. Classical Mechanics Third Edition. Addison-Wesley, San Francisco, 2002. pp 188-198 (hereinafter Goldstein). Also, the chemical fingerprint of the compound may be computed, according to RDKit. It will be understood that principle moments and other molecular physical properties, chemical fingerprints, binding models, and other such characteristics may be obtained in a variety of ways and the ones described herein are provided by way of example.

Then the principle electric moments of the molecule may be computed, as discussed in Goldstein. Also, the chemical fingerprint of the compound may be computed via standard methods (e.g. Topological Torsion: A New Molecular Descriptor for SAR Applications. Comparison with other Descriptors, Ramaswamy Nilakantan, Norman Bauman, J. Scott Dixon, and R. Venkataraghavan J. Chem. Inf. Comput. Sci., 1987, 27 (2), pp 82-85)) The chemical fingerprint is a way of representing chemical features by identifying their substructures. It may be represented as a series of binary values combined via “OR” operations into a long binary string. For example, an 8-bit fingerprint of a molecule may be represented as “10011001” or “00010111”. What each bit means (or chemical feature it maps to) depends on the chosen algorithm.

Finally, the physical properties, for example, as described in the section entitled “PHYSICAL PROPERTY ENUMERATION & STANDARDIZATION, may be combined into an input vector as in S2 of FIG. 4A. The input vector for this process may be an array of numeric values where each position represents a measurement with standard units. For example, we could create an input vector that represented mass, valence bond hybridization, formal charge, 1st electric moment, 2nd electric moment, and a 500-bit chemical fingerprint. The first position of the array may be the mass measurement (in units of Daltons, for example). The 2nd position of the array may be an 0-based index into a list of standard hybridizations (e.g. SP, SP2, SP3, etc.). An “SP” would be 0 where an “SP3” would be a 2. The 3rd and 4th values would be the electric dipole and quadrupole moments in units of Coulumb-meters and coulomb-meters squared, respectively. Array locations 5 through 504 would be the single-bit hash values of the chemical fingerprint. Any combination of these measurements may be supported as long as the array structure is consistent throughout the process. Additionally, all possible measurements may be represented in the array, and their value may be set to −1 if they have no corresponding measurement.

Once the input vector is created, we may then aggregate the data for the output vector. For each compound provided, public and/or proprietary data sources may be used by the system to obtain known molecular targets (S3 in FIG. 4A) and various binding descriptors including binding location, binding energy, binding affinity, association/disassociation constants for the compound-molecular target pair. Such information may be obtained, for example, from:
Kim S, Thiessen P A, Bolton E E, Chen J, Fu G, Gindulyte A, Han L, He J, He S, Shoemaker B A, Wang J, Yu B, Zhang J, Bryant S H. PubChem Substance and Compound databases. Nucleic Acids Res. 2016 Jan. 4; 44(D1):D1202-13. Epub 2015 Sep. 22 [PubMed PMID: 26400175] doi: 10.1093/nar/gkv95 (hereinafter Thiessen). RDKit, Open-Source Cheminformatics. http.//www.rdkit.org (hereinafter RDKit).
A. P. Bento, A. Gaulton, A. Hersey, L. J. Bellis, J. Chambers, M. Davies, F. A. Kruger, Y. Light, L. Mak, S. McGlinchey, M. Nowotka, G. Papadatos, R. Santos and J. P. Overington (2014) ‘The ChEMBL bioactivity database: an update.’ Nucleic Acids Res., 42 1083-1090 (hereinafter Bento).
S. Jupp, J. Malone, J. Bolleman, M. Brandizi, M. Davies, L. Garcia, A. Gaulton, S. Gehant, C. Laibe, N. Redaschi, S. M Wimalaratne, M. Martin, N. Le Novère, H. Parkinson, E. Birney and A. M Jenkinson (2014) The EBI RDF Platform: Linked Open Data for the Life Sciences Bioinformatics 30 1338-1339 (hereinafter Jupp). And Gautier Koscielny, Peter An, Denise Carvalho-Silva, Jennifer A. Cham, Luca Fumis, Rippa Gasparyan, Samiul Hasan, Nikiforos Karamanis, Michael Maguire, Eliseo Papa, Andrea Pierleoni, Miguel Pignatelli, Theo Platt, Francis Rowland, Priyanka Wankar, A. Patricia Bento, Tony Burdett, Antonio Fabregat, Simon Forbes, Anna Gaulton, Cristina Yenyxe Gonzalez, Henning Hermjakob, Anne Hersey, Steven Jupe, Senay Kafkas, Maria Keays, Catherine Leroy, Francisco-Javier Lopez, Maria Paula Magarinos, James Malone, Johanna McEntyre, Alfonso Munoz-Pomer Fuentes, Claire O'Donovan, Irene Papatheodorou, Helen Parkinson, Barbara Palka, Justin Paschall, Robert Petryszak, Naruemon Pratanwanich, Sirarat Sarntivijal, Gary Saunders, Konstantinos Sidiropoulos, Thomas Smith, Zbyslaw Sondka, Oliver Stegle, Y. Amy Tang, Edward Turner, Brendan Vaughan, Olga Vrousgou, Xavier Watkins, Maria-Jesus Martin, Philippe Sanseau, Jessica Vamathevan, Ewan Birney, Jeffrey Barrett, Ian Dunham; Open Targets: a platform for therapeutic target identification and validation, Nucleic Acids Research, Volume 45, Issue D1, 4 Jan. 2017, Pages D985-D994, https://doi.org/10.1093/nar/gkw1055 (hereinafter Koscielny).

### Molecular Target Classifier Creation

Using the data from these steps, a classifier (i.e. binding model) may be built to predict compound-target binding based on an input vector that includes such physical properties, as shown in FIG. 4A at S4, and an output vector that represents the known bindings and their attributes (e.g. binding energy, etc.). The goal of this classifier is to identify other likely binding sites and their attributes from the list of known biological targets whose relationships with the compounds have not previously been defined in the literature or other sources as shown in FIG. 4A at S4.

As an example, artificial intelligence means, such as gradient-boosted trees, deep neural networks, convolutional neural networks, graph-based convolutional neural networks, and Bayesian networks may be used to predict the bindings.

An example of how to train gradient boosted trees using Python is provided below:

The XGBoost python module is able to load data from:
libsvm txt format file
Numpy 2D array, and
xgboost binary buffer file.

The data is stored in a DMatrix object.
To load a libsvm text file or a XGBoost binary file into DMatrix:
dtrain=xgb.DMatrix(‘train.svm.txt’)
dtest=xgb.DMatrix(‘test.svm.buffer’)
To load a numpy array into DMatrix:
data=np.random.rand(5,10) #5 entities, each contains 10 features
label=np.random.randint(2, size=5) # binary target
dtrain=xgb.DMatrix(data, label=label)
To load a scpiy.sparse array into DMatrix:
csr=scipy.sparse.csr_matrix((dat, (row, col)))
dtrain=xgb.DMatrix(csr)
Saving D Matrix into a XGBoost binary file will make loading faster:
dtrain=xgb.DMatrix(‘train.svm.txt’)
dtrain.save_binary(“train.buffer”)
Missing values can be replaced by a default value in the DMatrix constructor:
dtrain=xgb.DMatrix(data, label=label, missing=−999.0)
Weights can be set when needed:
w=np.random.rand(5, 1)
dtrain=xgb.DMatrix(data, label=label, missing=−999.0, weight=w)

Setting Parameters

XGBoost can use either a list of pairs or a dictionary to set parameters. For instance:
Booster parameters
param={‘max_depth’:2, ‘eta’:1, ‘silent’:1, ‘objective’:‘binary:logistic’}param[‘nthread’]=4
param[‘eval_metric’]=‘auc’
You can also specify multiple eval metrics:
param[‘eval_metric’]=[‘auc’, ‘ams@0’]
# alternatively:
# plst=param.items( )
# plst+=[(‘eval_metric’, ‘ams@0’)]
Specify validations set to watch performance
evallist=[(dtest,‘eval’), (dtrain,‘train’)]

Training a model requires a parameter list and data set.
num_round=10
bst=xgb.train(plst, dtrain, num_round, evallist)

After training, the model can be saved.
bst.save_model(‘0001.model’)

The model and its feature map can also be dumped to a text file.
# dump model
bst.dump_model(‘dump.raw.txt’)
# dump model with feature map
bst.dump_model(‘dump.raw.txt’,‘featmap.txt’)

A saved model can be loaded as follows:
bst=xgb.Booster({‘nthread’:4}) #init model
bst.load_model(“model.bin”) # load data

Early Stopping

If you have a validation set, you can use early stopping to find the optimal number of boosting rounds. Early stopping requires at least one set in evals. If there's more than one, it will use the last.
train( . . . , evals=evals, early_stopping_rounds=10)

The model will train until the validation score stops improving. Validation error needs to decrease at least every early_stopping_rounds to continue training.

If early stopping occurs, the model will have three additional fields: bst.best score, bst.best_iteration and bst.best_ntree_limit. Note that train( ) will return a model from the last iteration, not the best one.

This works with both metrics to minimize (RMSE, log loss, etc.) and to maximize (MAP, NDCG, AUC). Note that if you specify more than one evaluation metric the last one in param[‘eval_metric’] is used for early stopping.

A model that has been trained or loaded can perform predictions on data sets.
#7 entities, each contains 10 features
data=np.random.rand(7, 10)
dtest=xgb.DMatrix(data)
ypred=bst.predict(dtest)

If early stopping is enabled during training, you can get predictions from the best iteration with bst.best_ntree_limit:
ypred=bst.predict(dtest,ntree_limit=bst.best_ntree_limit)

You can use plotting module to plot importance and output tree. To plot importance, use plot_importance. This function requires matplotlib to be installed.
xgb.plot_importance(bst)

To plot the output tree via matplotlib, use plot_tree, specifying the ordinal number of the target tree. This function requires graphviz and matplotlib.
xgb.plot_tree(bst, num_trees=2)

When you use IPython, you can use the to_graphviz function, which converts the target tree to a graphviz instance. The graphviz instance is automatically rendered in IPython.
xgb.to_graphviz(bst, num_trees=2)

Next, we define the input and output vectors that may be used to create the global toxicity model as shown in FIG. 4A S6-S13.

To start, a pool of clinical data may be obtained containing information regarding trial failure values and the underlying compounds being tested. The clinical data would typically include the overall outcomes, such as pass/fail to toxicity or the like. Such clinical trial data may be obtained from publicly available data sources or from an internal proprietary data source. Adverse events, for example, sourced from FDA (Federal Drug Administration) adverse events reporting system has such data or proprietary identity used, and this data can be scored using standard methods of toxicity, such as the World Health Organization's “Toxicity Criteria” and the score can be added to the output vector data set.

For example, the output vector could be represented as an array of values where the first location is a binary value showing whether the clinical trial passed or failed. The second location could be an FMEA (Failure Mode and Effects Analysis) score that ranks the relative weights of the side effects, their likelihood of occurrence and their severity. The next 10 locations could be scalar values corresponding to the likelihood that the compound in question will lead to particular side effects of interest (e.g. heart failure, stroke, kidney damage, etc.)

For each compound obtained, the process listed in the above-provided section “PHYSICAL PROPERTY ENUMERATION & STANDARDIZATION” may be used to extract the physical properties. These properties may be used as parts of the input vector to the model.

Next, known binding sites may be obtained in a similar fashion to S8 in FIG. 4A described earlier. This information may be added to the input vector. If binding energies or similar metrics are used, they may be added as scalar values. Known binding sites may be added as 1-hot encodings. It will be understood that values described as scalar may in some implementations be provided as Booleans corresponding to ranges, or represented or input in other ways.

Next, the input vector from the prior step defined in the above-provided section entitled “MOLECULAR TARGET CLASSIFIER CREATION” may be entered to the model to identify additional potential binding sites and to update the input vector accordingly.

For each clinical trial, a therapeutic area (TA) may be found and indicated for the compound. The therapeutic area may be important because coupled with the gene expression data, this information may tell you whether the compound or drug is targeting the correct tissues. If it is not targeting the correct tissues, the drug may be toxic. The therapeutic area may be obtained using machine language methods, such as natural language processing (NLP), fuzzy string matching, or the like acting on the clinical trial description, or by manually labeling each clinical trial. The result of this will map the disease and compound in question to a particular body system (e.g. respiratory, cardiovascular, etc.) or a similar reference ontology (e.g. the National Library of Medicine's MeSH hierarchy). The clinical trial adverse event severity score may serve as the predicted value in the model for the system. Additionally, the clinical trial compound, indication for use, phase, and other similar details of the trail may be added as part of the input vector feature set using one-hot encoding or scalar indexing. The obtaining of the predicted values is shown in S5 of FIG. 4A.

As shown in FIG. 4A, S10, gene interactions may be enumerated for each target molecule (or molecules). Thus, the total in vitro gene activation by the targets(s) may be scored using known data sets. The score may be based upon a weighted sum of the data obtained in steps S6-S7. The output may be a combination of a list of genes and gene activation metrics. Gene activation metrics are typically measured as the relative strength of gene expression in a cell treated with drug compared with a baseline value in a control cell that was untreated. The expression is typically measure via a proxy such as quantitfy of mRNA generated. For each identified target in the prior step, the genetic pathway that the identified target controls may be enumerated using sources, such as Bento, Jupp and Koscielny.

For each of the identified gene interactions of step S10 in FIG. 4A, as shown in FIG. 4B, S12, the gene expression strength may be identified in individual tissues throughout the body, using, for example, information available in Robert Petryszak, Maria Keays, Y. Amy Tang, Nuno A. Fonseca, Elisabet Barrera, Tony Burdett, Anja Füllgrabe, Alfonso Muñoz-Pomer Fuentes, Simon Jupp, Satu Koskinen, Oliver Mannion, Laura Huerta, Karine Megy, Catherine Snow, Eleanor Williams, Mitra Barzine, Emma Hastings, Hendrik Weisser, James Wright, Pankaj Jaiswal, Wolfgang Huber, Jyoti Choudhary, Helen E. Parkinson, Alvis Brazma; Expression Atlas update—an integrated database of gene and protein expression in humans, animals and plants, Nucleic Acids Research, Volume 44, Issue D1, 4 Jan. 2016, Pages D746-D752, https://doi.org/10.1093/nar/gkv1045 (hereinafter Petnszak) and

Edgar R, Domrachev M, Lash A E. Gene Expression Omnibus: NCBI gene expression and hybridization array data repository Nucleic Acids Res. 2002 Jan. 1; 30(1):207-10 (hereinafter Domrachev). The gene expression strength is a metric of a relative expression strength of a set of gene expression locations in the body, which may be expressed as Boolean (yes or no) or as a scalar to indicate expression strength relative to other tissues of body areas. It will be understood that values or data or scores described as being expressed as Boolean may be represented as scalar value or in other ways.

For example, the gene PIK3CA in humans is expressed in the gut at a level of 13 TPM, parietal lobe tissue at a level of 0 TPM and the pituitary gland at a level of STPM. If we were modeling PIK3CA activity in these three tissues, we would create a vector where each slot represents the specific measurement for the given tissues. A scalar activity vector might look like v_PIK3CA=[13,0,5], where the first value is the measurement for the gut activity, the second value is the measurement for the parietal lobe activity and the third value is the measurement for the pituitary gland activity, all in the same units. If we were to convert this to a Boolean vector, it would be represented as v_PIK3CA=[1,0,1] because PIK3CA shows activity in the gut and pituitary gland, but not the parietal lobe. A value of “1” states that there is gene activity present in that location where a value of “0” states that there is no activity. Any additional tissue locations would be represented as additional elements in this array. The precise order of the elements is not important as long as it is preserved across all steps of the model and inference.

Then, as shown in S13 of FIG. 4B, for each compound, an indication of the compound and a phase may be obtained from the clinical data. The clinical data may be annotated with a therapeutic area and/or an ATC (Anatomical Therapeutic Chemical Classification System) code using a publicly available or other information. Such labels of the therapeutic area and/or the ATC code can describe what tissues are the purported targets in clinical trials and, therefore, what tissues are not such targets. If a compound has effects against a non-therapeutic area, this may be an indication of an adverse effect or an undesirable outcome.

In S14 in FIG. 4A, the input and output vector data may be aggregated into a machine learning model to predict or score the suitability, relative toxicity or potential side effects of the compound. Suitability/unsuitability scoring may indicate or represent one or more of failure in any phase of the clinical trial due to toxicity, failure of a compound to obtain FDA approval for sale or marketing due to toxicity, an adverse effect scoring, an adverse effect severity, relative to toxicity compared to other compounds and relative toxicity to other compounds compared to competitive market. The suitability/unsuitability score may also indicate a degree of such toxicity on an absolute toxicity/adverse effect scale, for example, expressed as a scalar or logarithmic value. The score may be thought of as an unsuitability score if a higher absolute value indicates a greater degree of toxicity, lack of efficacy or likelihood of clinical failure or the like.

The machine learning or artificial intelligence process may include one or more of gradiant-boosted tree methods, deep neural network methods, convolutional neural network methods, graph-based convolutional neural network methods, and Bayesian network methods.

During this training phase, the output of the machine learning may be an optimized score so as to minimize prediction error and/or to maximize the maximum likelihood estimate for compound suitability. Such maximization may include automatically segmenting the data into a training data set and a testing data set.

The segmenting of the data is shown in S15 of FIG. 4A. The testing data set includes compounds for which suitability scores are known based on clinical data. Then, the processes of the above-described machine learning modalities may be adjusted or fine-tuned, for example, a deep neural network may be used with more or fewer levels so as to increase the accuracy of the model. More than one such machine language modality may be used in parallel so as to test the modality against the testing data set and thus to choose the more accurate machine learning modality. For example, a gradient-boosted tree method and a deep neural network may both be run, so as to compare the results against each other, as judged by the testing data set, or against results from a further machine learning approach, such as graph-based convolutional neural network method result. Optimization is shown in FIG. S16 of FIG. 4A.

Further, according to an aspect of the disclosure, the model can then be updated based on new clinical data, as shown in S17 of FIG. 4A, without having to retrain the system, so that online learning may be facilitated. Such additional clinical data may also be input from a proprietary database of a subscriber or customer using the system, from a vendor providing access to clinical data, or from other sources.

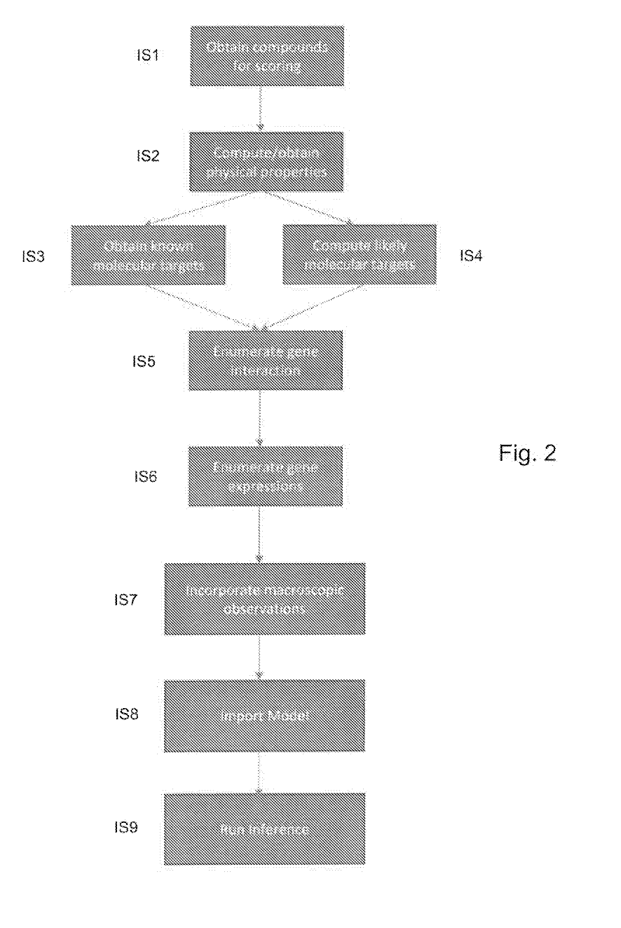

Processing of compounds of interest is as follows. The compound of interest to score, or some description of the compound is received, for example, via a user interface, as shown in S19 of FIG. 4B and at IS1 of FIG. 2. For example, a generic name, brand name, chemical name or Isomeric SMILES of the compound in question may be received. Information about the compound is obtained, along with targeted indication and therapeutic area. The targeted indication may be retrieved from data source different from the data source of therapeutic area, as shown in S20 of FIG. 4B and in IS3 and 4 of FIG. 2. The molecule may be standardized using common molecular standardization and validation methods as shown in S21 of FIG. 4B.

Physical properties of the compound are extract in the fashion of the above-provided section entitled “PHYSICAL PROPERTY ENUMERATION & STANDARDIZATION” as per S22-S23 in FIG. 4C.

Biological properties of the compound are extracted in the fashion of the above-provided section entitled “MOLECULAR TARGET CLASSIFIER CREATION” as shown in S24-S27.

Based on this input information, analysis can be run so that the algorithm automatically generates a metric indicating a likelihood that a compound will fail in any phase of Clinical Trials due to toxicity, a likelihood that a compound will fail to obtain FDA approval for sale/marketing due to toxicity, a metric scoring the likelihood of adverse effects, a metric scoring the likely severity of adverse effects, a relative toxicity of a series of compounds compared to each other, a relative toxicity of the compound compared to the competitive market. This is shown in S28 in FIG. 4C and in IS9 of FIG. 2.

For example, assume we are modeling relative toxicity and likelihood of trail failure. The output vector may consist of 2 scalar elements, a value ranging from 0-1 showing the relative toxicity and a value 0-1 showing the likelihood of trial failure. A relative toxicity of 0 represents the lowest possible toxicity of any compound where a toxicity of 1 represents the highest possible toxicity of any compound. These do not necessarily correlate with likelihood of trial success, though. For example, a drug used in oncology can be designed to destroy cells in the body. It might have a high toxicity score (i.e. >0.7) because it also targets healthy tissue in other systems, but also may have a high likelihood of success (i.e. >0.5) because it is effective in treating the disease. However a drug that treats minor pediatric maladies might have a lower toxicity score (i.e. 0.4) but may have a low likelihood of success (i.e. <0.1) because the overall toxicity is too much of a risk compared with leaving the disease untreated.

According to an aspect of the disclosure, an indication for the compound and/or therapeutic area for the compound may be identified. The coupling of this information with the gene expression data can determine whether the drug is targeting the correct tissues, and otherwise it may be toxic.

According to an aspect of the disclosure, the possibility of more than one binding site/target per compound is provided for and handled by the system.

According to an aspect of the disclosure, additional binding sites and their physical properties are predicted by the model(s).

According to an aspect of the disclosure, an adverse event severity score is used.

According to an aspect of the disclosure, several machine learning modeling options may be deployed and optimized.

According to an aspect of the disclosure, offline and online training are provided, and thus the model may get updated as new information is obtained as in S29 in FIG. 4C.

According to an aspect of the disclosure, a host of physical properties of the compound and atoms thereof may be used as part of the input vector.

According to an aspect of the disclosure, electric moment, principle moments and/or molecular fingerprints may be used in the models.

The present methods, functions, systems, computer-readable medium product, or the like may be implemented using hardware, software, firmware or a combination of the foregoing, and may be implemented in one or more computer systems or other processing systems, such that no human operation may be necessary. That is, the methods and functions can be performed entirely automatically through machine operations, but need not be entirely performed by machines. A computer or computer systems including compound suitability profiler 20 as described herein may include one or more processors in one or more units for performing the system according to the present disclosure, and these computers or processors may be located in a cloud or may be provided in a local enterprise setting or off premises at a third party contractor.

Trainer 30 and inference 70 may be provided on the same physical machine run by the same operating system or as part of the same data center, such as in the same rack, or may be provided in entirely different locations remote from each other.

The data interface 31 and the user interface 32 may include a wired or wireless interface communicating over TCP/IP paradigm or other types of protocols, and may communicate via a wire, cable, fire optics, a telephone line, a cellular link, a radio frequency link, such as WI—FI or Bluetooth, a LAN, a WAN, VPN, or other such communication channels and networks, or via a combination of the foregoing.

Accordingly, a method, system, device and the means for providing such a method are described for providing improved flagging or detection of compounds that are unpromising or unsuitable, so that clinical research may focus on more promising pharmaceutical compounds. Accordingly, laboratory and clinical research may be facilitated and resources may be preserved and focused on the most promising compounds and research areas.

Although the present invention has been described in relation to particular embodiments thereof, many other variations and modifications and other uses will become apparent to those skilled in the art. Steps outlined in sequence need not necessarily be performed in sequence, not all steps need necessarily be executed and other intervening steps may be inserted. It is preferred, therefore, that the present invention be limited not by the specific disclosure herein.

What is claimed is:

1. A system for generating an suitability and/or toxicity score for a compound of interest, the system comprising:
a known clinical outcome score generator configured to generate a set of suitability outcome scores for a first set of compounds based on a set of clinical known trial data, each suitability outcome score of the suitability outcome scores representing an outcome of a clinical trial of a compound of the first set of compounds;
a compound physical property data processor configured to obtain physical properties of a molecule or of atoms of each compound of a first set of compounds, and configured to obtain a known molecular target of each compound of a first plurality of compounds of the first set of compounds;
a binding classifier configured to predict for compounds of a second plurality of the first set of compounds respective molecular targets;
a therapeutic area indicator configured to obtain for each compound of the first set of compounds a therapeutic area; and
a trainer configured to generate a set of suitability scores yielded, respectively, by a set of inputs, each input including a compound of the first set of compounds, the set of suitability scores generated, based on the therapeutic area data generated, using a machine learning process comprising at least one of a gradient-boosted tree method, a deep neural network method, a convolutional neural network method, a graph-based convolutional neural network method, and a Bayesian network method.

2. The system of claim 1, further comprising a machine learning optimizer configured to optimize the machine learning of the trainer based on a testing data set comprising a set of input vectors and scored suitability outcomes.

3. The system of claim 1, further comprising a machine learning optimizer configured to optimize the machine learning of the trainer based on a testing data set comprising a set of input vectors, each input vector of the set of input vectors comprising a first known molecular target, a first known binding descriptor set, and a first set of physical compound properties.

4. The system of claim 1, further comprising a compound inferencer configured to generate the suitability score for the compound of interest based on the set of suitability scores generated by the trainer.

5. The system of claim 1, further comprising:
a gene interaction enumerator configured to obtain a genetic pathway controlled by a respective molecular target;
a gene expression metric generator configured to identify a metric of gene expression strength for each tissue of a plurality of tissues.

6. The system of claim 5, wherein the gene interaction enumerator is configured to obtain the set of genetic pathways from a database.

7. The system of claim 5, wherein the gene interaction enumerator is configured to generate the suitability score based upon a weighted sum of gene interactions.

8. The system of claim 5, wherein the gene expression metric generator is configured to identify the metric as a metric of the relative expression strength and a Boolean expression location, and
the therapeutic area indicator is configured to generate therapeutic area data by obtaining a therapeutic area according to the expression strength metric of the respective compound.

9. The system of claim 1, wherein the compound physical property data processor is configured to obtain physical properties including at least one of molecular mass, water solubility, xLogP, refractivity, chirality, electromagnetic moments, atomic bond energies, atomic orbitals, H-bond donor/acceptor counts, molecular surface area, and intrinsic coordinates.

10. The system of claim 1, wherein the compound physical property data processor is configured to compute a chemical fingerprint.

11. The system of claim 1, wherein the compound physical property data processor is configured to obtain a standard molecular physical property from a database.

12. The system of claim 1, wherein the compound physical property data processor is configured to extract, for each atom in a molecular of a compound, relative Cartesian coordinates, valence, hybridization, and formal change.

13. The system of claim 1, wherein the compound physical property data processor is configured to compute an electric moment using hybridization and formal change.

14. The system of claim 1, wherein the compound physical property data processor is configured to compute principle moments of a molecule of the compound.

15. The system of claim 1, wherein the compound physical property data processor is configured to compute a chemical fingerprint of the compound.

16. The system of claim 1, wherein the suitability score indicates a likelihood that a compound will fail in any phase of clinical trials due to toxicity.

17. The system of claim 1, wherein the suitability score indicates a likelihood that a compound will fail to obtain regulatory approval for sale due to toxicity.

18. The system of claim 1, wherein the suitability score is a metric indicating a likely severity of adverse effects of a compound.

19. The system of claim 1, wherein the suitability score indicates a relative toxicity of a compound compared to another compound.

20. The system of claim 1, wherein the suitability score indicates a relative toxicity of a compound compared to a competitive market of a compound.

21. The system of claim 1, wherein the suitability score indicates at least one of suitability or toxicity of the compound.

22. The system of claim 1, further comprising a binding classifier builder configured to build a binding classifier that predicts binding between a first compound of a third set of compounds and a first molecular target of a third set of molecular targets based on physical properties of the first compound, and to predict binding between a second compound of the third set of compounds and a second molecular target of the third set of molecular targets based on the physical properties of the second compound,
the binding classifier builder configured to build the binding classifier builder by obtaining from a database, for each compound of a second set of compounds, a known molecular target, known binding descriptors, and physical compound properties,
wherein the binding classifier builder builds the binding classifier using a first machine learning process comprising at least one of a gradient-boosted tree method, a deep neural network method, a convolutional neural network method, a graph-based convolutional neural network method, and a Bayesian network method.

23. The system of claim 1, wherein the system automatically standardizes the compound before obtaining the physical properties.

24. A method of generating a suitability score for a compound of interest, the system comprising:
generating a set of suitability outcome scores for a first set of compounds based on a set of clinical trial data, each suitability outcome score of the suitability outcome scores representing an outcome of a clinical trial of a compound of the first set of compounds;
obtaining physical properties of a molecule or of atoms of each compound of a first set of compounds, and obtaining a known molecular target of each compound of a first plurality of compounds of the first set of compounds;
obtaining for each compound of the first set of compounds a therapeutic area; and
generating a set of suitability scores yielded, respectively, by a set of inputs, each input including a compound of the first set of compounds, the set of suitability scores generated using a machine learning process comprising at least one of a gradient-boosted tree method, a deep neural network method, a convolutional neural network method, a graph-based convolutional neural network method, and a Bayesian network method.

25. The method of claim 24, further comprising:
predicting, for compounds of a second plurality of the first set of compounds, a respective first set of molecular targets;
obtaining a genetic pathway of a set of genetic pathways controlled by a respective molecular target of the first set of molecular targets; and
identifying a metric of gene expression strength for each tissue of a plurality of tissues.

26. A system for generating a suitability and/or toxicity score for a compound of interest, the system comprising:
a physical properties obtainer configured to obtain physical properties of the compound;
a binding sites obtainer configured obtain physiological binding sites or targets of the compound;
a machine-learner configured to predict additional physiological binding sites or targets of the compound; and
an inference configured to determine at least one of suitability or toxicity for a compound of interest based upon the machine-learner prediction and to output a result of the determination of the at least one of suitability or toxicity.

27. The system of claim 26, further comprising:
a compound clinical descriptions obtainer configured to obtain clinical descriptions for the compound.

28. The system of claim 27, wherein the clinical descriptions for the compound include at least one of an indication for use of the compound and a therapeutic area of the compound.

29. The system of claim 26, further comprising:
a known compound trainer configured to receive known clinical trial results and compound toxicity scores for a given compound, and to update the machine-learner accordingly.

30. The system of claim 29, wherein the known compound trainer is configured to update the machine learner on-line.
